(19) United States
(12) Patent Application Publication
(10) Pub. No.: US 2012/0298481 A1
(43) Pub. Date: Nov. 29, 2012

(54) MULTIWHEEL ROLLER-CONVEYOR CASE TURNER

(75) Inventor: Matthew L. Fourney, Laurel, MD (US)

(73) Assignee: LAITRAM, L.L.C., Harahan, LA (US)

(21) Appl. No.: 13/114,114

(22) Filed: May 24, 2011

(51) Int. Cl. B65G 47/244

(52) U.S. Cl. 198/413

(57) ABSTRACT

A case turner constructed of parallel lanes of powered multiwheel rollers rotating at different tangential speeds. Rotatable wheels mounted on the peripheries of each multiwheel roller are arranged to rotate freely on axes perpendicular to the main axis of the powered multiwheel roller. An article straddling the gap between both lanes is rotated as it is conveyed along the case turner.

### BACKGROUND

The invention relates generally to power-driven conveyors and, more particularly, to belt conveyors and methods for turning cases using conveyor belts with selectively actuated, case-supporting rollers.

Traditional case-turning conveyors use two lanes of powered rollers arranged parallel to each other. The powered rollers in one lane are rotated with a tangential speed different from the tangential speed of the rollers in the other lane. When a package is fed onto and bridges the two lanes, the faster rollers pull one side of the package ahead, causing the package to rotate atop the rollers, its leading edge moving toward the row of slower rollers. The package continues to rotate as it is conveyed along the conveyor in a conveying direction. Smooth, low-friction peripheral surfaces on the rollers allow the package to slide across the peripheries of the rotating rollers. But the low-friction surfaces of the rollers also allow a package to slip in the conveying direction, which means that a greater distance in the conveying direction is required for rotation. Thus, there is a need for a case turner that can turn packages in a short distance.

### SUMMARY

One version of a case-turning conveyor embodying features of the invention comprises a first lane of powered multiwheel rollers spaced apart and arranged to rotate on first main axes perpendicular to a conveying direction and a second lane of powered multiwheel rollers spaced apart and arranged to rotate on second main axes perpendicular to the conveying direction. The second lane is adjacent to the first lane across a gap. A drive system rotates the powered multiwheel rollers in the first lane at first speeds and the powered multiwheel rollers in the second lane at second speeds. The powered multiwheel rollers of the first and second lanes have article-supporting wheels on their peripheries. The article-supporting wheels are free to rotate on multiple axes that are perpendicular to the first and second main axes of the powered multiwheel rollers.

### BRIEF DESCRIPTION OF THE DRAWINGS

These features and aspects of the invention are exemplified in more detail in the following description, appended claims, and accompanying drawings, in which:

FIG. 1 is an isometric view of a portion of a case-turning conveyor embodying features of the invention;

FIG. 2 is an isometric view of a portion of a powered multiwheel roller of the case-turning conveyor of FIG. 1;

FIG. 3 is an enlarged isometric view of a portion of the case-turning conveyor of FIG. 1 showing a sensor for sensing a conveyed article; and

FIG. 4 is a block diagram of a control system usable with a case-turning conveyor as in FIG. 1.

### DETAILED DESCRIPTION

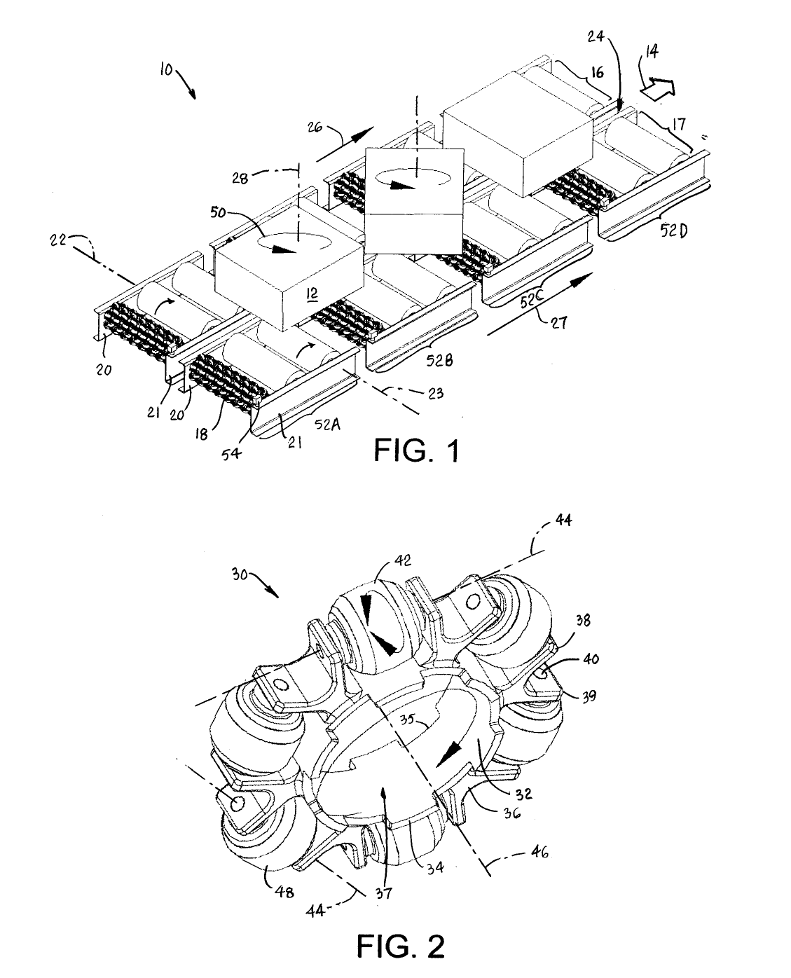

One version of a case-turning conveyor, or a case turner, is shown in FIG. 1. The case turner 10 is shown conveying an article 12, such as a package or box, in a conveying direction 14 atop two parallel lanes 16, 17 of powered multiwheel rollers 18. The rollers are powered by motors internal or external to each roller or by drive belts or drive rollers powered individually or in groups. The rollers in each lane 16, 17 are regularly spaced apart along the length of the conveyor between parallel side rails 20, 21 that support the opposite ends of the rollers' axles and form a pair of side-by-side roller conveyors. The main axes 22, 23 of the rollers in the first and second lanes 16, 17 are perpendicular to the conveying direction 14. (In FIG. 1, only some of the rollers are drawn as multiwheel rollers to simplify the drawing, but all the rollers are meant to be multiwheel rollers.) The rollers 18 in each lane 16, 17 are separated from each other across a gap 24 between the inner side rails. Although the rollers in the first lane 16 are shown axially aligned with the rollers in the second lane 17, they could be offset along the length of the case-turning conveyor 10. A drive system (not shown in FIG. 1) rotates the rollers in the first lane 16 at first tangential speeds 26 and the rollers in the second lane 17 at second tangential speeds 27. In a simplified version of the case turner, the drive system rotates all the rollers in the first lane at the same first speed and all the rollers in the second lane at the same second speed, but with the first speed slower than the second speed to rotate the article 12 counterclockwise about a vertical axis 28. In more complex embodiments, the speeds of each roller can be individually controlled by the drive system for more precise and rapid article rotation.

Each multiwheel roller 18 includes a set of wheel rings 30 as shown in FIG. 2 axially ganged together to form the periphery of the roller. Each wheel ring has an inner band 32 castellated along each edge 34, 35 to mate with adjacent rings. The ganged bands form a bore 37 that receives and is affixed to the outer shell of a conventional powered roller or forms the outer shell of a powered roller. Six wheel supports 36 each extend radially outward to a forked pair of stanchions 38, 39 at distal ends of the supports. In this version, the six supports are uniformly circumferentially spaced around the ring every 60°. Each stanchion supports an end of an axle 40 of a freely rotatable wheel 42. In this version, each adjacent wheel ring 30 is circumferentially offset 30° from its adjacent wheel rings by the mating of the castellated edges 34, 35 of the inner bands 32. In this way, the wheels 42 are more uniformly distributed around the periphery of the roller for better engagement with conveyed articles. The axes 44 of the axles 40 of the freely rotatable wheels are oriented perpendicular to the axis 46 of the inner band and, consequently, to the main axes 22, 23 of the multiwheel rollers. The wheels 42 in each ring 30 orbit the ring's axis of rotation 46 in the plane containing wheels' axes 44 as the roller rotates. Because the freely rotatable wheels rotate on axes perpendicular to the ring's axis, they provide low-friction rolling contact in the width direction of the conveyor, i.e., parallel to the main axes 22, 23, to conveyed articles. To prevent articles from slipping atop the wheels 42 in the axial direction, i.e., in the conveying direction, a rubber, elastomeric, or other high-friction surface layer 48 can be provided on the peripheries of the wheels. Other multiwheel constructions with, for example, different numbers of rollers or different roller patterns or different mounting means from the exemplary version shown in the drawings could be used.

As shown in FIG. 1, the multiwheel rollers 18 in the left-hand lane 16 are driven at a lower speed 26 than the higher speed 27 of the rollers in the right-hand lane 17. Because the rollers in the right-hand lane 17 are rotating faster than the rollers in the left-hand lane 16, the article 12 straddling the gap 24 between the two lanes is rotated counterclockwise about its vertical axis 28, as indicated by the curved arrow 50, while the article is conveyed along the length of the conveyor 10. The freely rotatable wheels 42 in the rollers facilitate rotation by providing rolling contact with the articles. The lower speed 26 is set to match the overall case rate, i.e., the flow rate of articles on infeed and downstream conveyors. The differential speed, i.e., the difference between the higher speed 27 and the lower speed 26, is set to provide the desired degree of rotation. The differential speed may also depend on physical characteristics of the article, such as the shape of its bottom, its weight, and the coefficient of friction between the bottom of the article and the rollers. The speeds of the rollers in the two lanes may be set to predetermined speeds based on the desired degree of rotation and the known length of the conveyor.

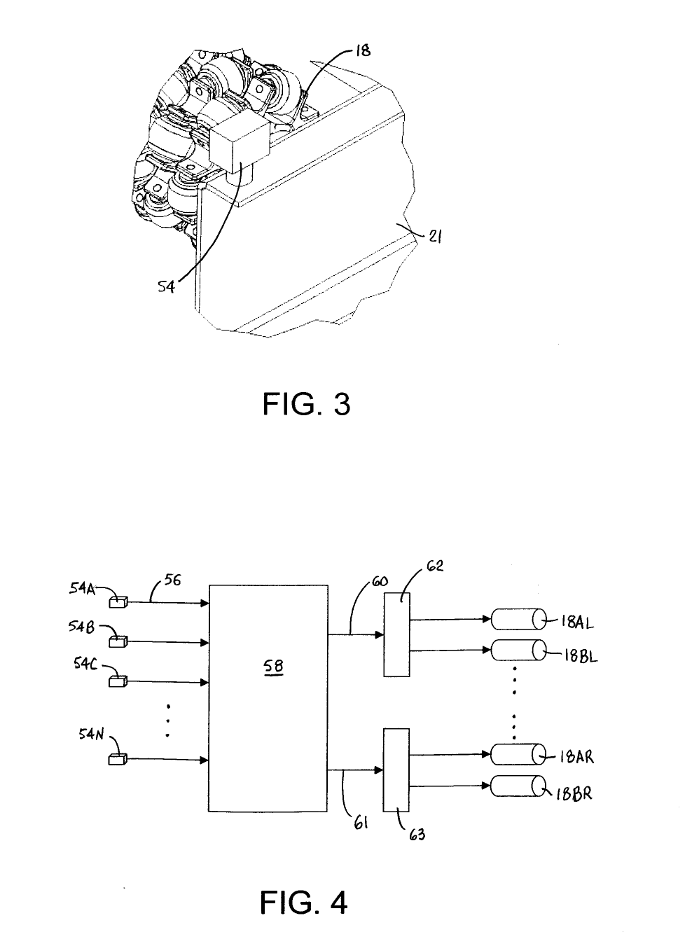

More precise control can be achieved by individually controlling the rotational speed of each multiwheel roller individually or in groups of consecutive rollers. As shown in FIGS. 1 and 3, the case turner 10 is divided into four zones 52A-52D along its length. A sensor 54 is positioned at a sensor location in each zone. In this example, the sensor location is at the entrance to each zone. The sensor 54, which may be an optical sensor or a proximity switch, detects the presence of a conveyed article 12 at the sensor location and provides a signal 56 indicating the presence of a conveyed article to a controller 58, as in FIG. 4. The sensor signal changes state when an article is absent from the sensor location. The controller can time the intervals between the changes of state of the sensor signal and, with a priori knowledge of the dimensions of the article and knowledge of the speed of the rollers, can determine the orientation of the article. Using more sophisticated visioning systems, the controller can use video signals from vision sensors and imaging software to determine the orientation of the article. With the orientation information, the controller can send control signals 60 to the drive mechanism 62 to rotate an individual multiwheel roller 18 or a group of multiwheel rollers 18AL, 18BL, etc. in the left-hand lane 16 to rotate at a specified speed to produce the desired amount of article rotation. At the same time, the controller 58 sends control signals 61 to the drive mechanism portion 63 controlling the multiwheel rollers 18AR, 18BR, etc. in the right-hand lane 17, to adjust the differential speed for proper rotation of the article. By adjusting the magnitude of the speeds and the differential speeds between the two lanes, the controller can rotate an article a desired amount in a desired distance along the length of the conveyor and can rotate the rollers in both lanes of a zone at the same speed to stop article rotation.

What is claimed is:

1. A case turner comprising:
a first lane of powered multiwheel rollers spaced apart and arranged to rotate on first main axes perpendicular to a conveying direction;
a second lane of powered multiwheel rollers spaced apart and arranged to rotate on second main axes perpendicular to the conveying direction, wherein the second lane is disposed adjacent to the first lane across a gap;
a drive system for rotating the powered multiwheel rollers in the first lane at first speeds and the powered multiwheel rollers in the second lane at second speeds;
wherein the powered multiwheel rollers of the first and second lanes include a plurality of article-supporting wheels on the peripheries of the powered multiwheel rollers, the article-supporting wheels being freely rotatable on multiple axes perpendicular to the first and second main axes.

2. A case turner as in claim 1 wherein each of the powered multiwheel rollers in the first lane is axially aligned with one of the powered multiwheel rollers in the second lane.

3. A case turner as in claim 1 wherein the article-supporting wheels have a high-friction peripheral surface layer.

4. A case turner as in claim 1 wherein the first speeds of all the multiwheel rollers in the first lane are the same and the second speeds of all the multiwheel rollers in the second lane are the same, but different from the first speeds.

5. A case turner as in claim 1 wherein the drive system controls each of the multiwheel rollers in the first and second lanes individually.

6. A case turner as in claim 1 further comprising one or more sensors disposed at sensor locations along the first and second lanes to provide signals indicating the presence of conveyed articles on the case turner at the sensor locations.

7. A case turner as in claim 6 further comprising a controller receiving the signals from the one or more sensors and determining the orientation of the articles at the sensor locations from the signals and controlling the drive system to adjust the first and second speeds depending on the orientations.
